(19) United States
(12) Patent Application Publication
(10) Pub. No.: US 2006/0165433 A1
(43) Pub. Date: Jul. 27, 2006

(54) A PROCESS CARTRIDGE FOR AN IMAGE FORMING APPARATUS

(75) Inventors: Christopher Paul Mercer, Dongara (AU); Samuel Wai Keung Tsui, Shenzen (CN)

Correspondence Address: GCC IP PTY LTD, P. O. BOX 2920, GERALDTON, WA 6531, AU

(73) Assignee: GCC IP PTY LTD, Geraldton (AU)

(21) Appl. No.: 10/905,927

(22) Filed: Jan. 27, 2005

(51) Int. Cl. G03G 21/18

(52) U.S. Cl. 399/111

(57) ABSTRACT

A bearing is provided at each longitudinal end of the cartridge frame. The bearing has mounting apertures for mounting the developing roller and regulating blade, and for maintaining a predetermined spacing between the developing roller and the regulating blade. The bearing is moveable relative to the cartridge frame to allow relative movement between the developing roller and photosensitive drum. A coil spring is also provided to bias the bearing toward the drum to create the required gap between the developing roller and drum. The gap is maintained by spacers mounted on the longitudinal ends of the developing roller. In addition, an abutting portion is provided on the bearing and is engageable with a stop portion on the cartridge frame to limit movement of the bearing toward the operative position photosensitive member. The abutting and stop portions serve to limit the movement of the bearing even when the photosensitive drum is not installed in the cartridge, for example, during assembly and disassembly of the cartridge.

### FIELD OF THE INVENTION

The invention relates to a bearing for supporting a developing roller in a process cartridge for an image forming apparatus. The bearing is suitable for use in laser printers, laser photocopiers and laser facsimile machines, and will be described hereinafter with reference to such applications. However, it will be appreciated that the invention is not limited to this particular field of use.

### BACKGROUND TO THE INVENTION

Toner cartridges for laser printers, copiers and multi function devices are well known in the art. Typically, toner cartridges comprise a developing roller for developing a latent image on a photosensitive member, such as a photosensitive drum or sheet. Toner is usually supplied to the developing roller by an agitating member, sometimes in conjunction with a supply roller. The amount of toner supplied to the developing roller is usually controlled by a regulating blade, which is pressed against the developing roller so as to limit the thickness of the toner layer formed on the roller.

The developing roller is usually translationally fixed with respect to the cartridge frame, but is allowed to rotate relative to the frame. It is also common for the regulating blade to be fixedly connected to the frame. Accordingly, since these two components are translationally fixed with respect to one another, the cartridge frame, developer roller and regulating blade must all be accurately constructed to ensure that a correct spacing and pressing force is provided between the regulating blade and developing roller and between the developer roller and the photosensitive drum.

Moreover, it will be appreciated that the drum and developer roller surfaces, as well as the regulating blade surface, abrade and wear over time. Accordingly, the spacing between these components changes during the life of the cartridge, and if the spacing between the components is fixed, then print quality problems due to wear can result.

It is an object of the present invention to overcome or ameliorate one or more of the disadvantages of the prior art, or at least to provide a useful alternative thereto.

### SUMMARY OF THE INVENTION

Accordingly, in a first aspect the invention provides a process cartridge for an image forming apparatus, said process cartridge comprising:
a cartridge frame;
a toner bearing member rotatably mounted to the frame, the toner bearing member being adapted for developing a latent image carried on a photosensitive member;
a regulating blade engageable with the toner bearing member for regulating an amount of toner carried on the toner bearing member;
a bearing engageable with the cartridge frame for mounting the toner bearing member and regulating blade, the bearing member maintaining a predetermined spacing between the toner bearing member and the regulating blade;
wherein the bearing is moveable relative to the cartridge frame.

Preferably, the bearing is resiliently biased toward a position wherein, in use, the toner bearing member opposes the photosensitive member.

Preferably, an abutting portion is provided on the bearing and is engageable with a stop portion on the cartridge frame to limit movement of the bearing toward the photosensitive member.

Preferably, the bearing includes an aperture for engagement by a supporting bracket of the regulating blade.

Preferably, the bearing includes an aperture for engagement by a shaft connected to the toner bearing member. More preferably, a potential bias contact for the toner bearing member is connected to the shaft, such that the potential bias contact moves as the bearing moves.

Preferably, the bearing is resiliently biased by a compression spring toward a position wherein, in use, the toner bearing member opposes the photosensitive member. More preferably, the spring has a spring constant of between around 0.5 kN/m and around 10 N/m. Even more preferably, the spring constant is between around 1.0 kN/m and around 4.0 kN/m. In a preferred embodiment the spring constant is between around 1.5 kN/m and around 3.0 kN/m.

Preferably, the bearing has a boss for locating the spring.

Preferably, the bearing is located in a recess in the cartridge frame. More preferably, the recess is configured to restrict movement of the bearing to a single plane. In a preferred form, the recess has opposite parallel guide walls that cooperate with opposite parallel outer walls of the bearing so as to restrict movement of the bearing to a single plane. Preferably, a longitudinally outer edge of the bearing is substantially flush with a corresponding longitudinal end face of the cartridge frame.

Preferably, the cartridge frame includes an outer frame for mounting the drum and a sub-frame to which the toner bearing member and regulating member are mounted via said bearing. More preferably, a charging member is also mounted to the sub-frame for charging the photosensitive member. Preferably, both ends of the charging member are mounted to the sub-frame by respective C-shaped clips that are spring mounted to the sub-frame. More preferably, the C-shaped clips are integrally formed as part of the sub frame. Even more preferably, respective compression springs are provided to resiliently bias the C-shaped clips toward the photosensitive member.

Preferably, the sub-frame includes an end plate at its opposite longitudinal ends. More preferably, the recess for the bearing is provided in the end plate. Even more preferably, the end plate has an arcuate supporting surface for supporting a photosensitive drum. In a preferred form, the end plates are connected to opposite longitudinal ends of a rigid supporting frame.

Another aspect of the invention provides a method of manufacturing or remanufacturing a process cartridge including the steps of:

providing a cartridge frame;

providing a toner bearing member rotatably mounted to the frame, the toner bearing member being adapted for developing a latent image carried on a photosensitive member; mounting the toner bearing member to the frame such that the toner bearing

member is allowed to move in at least one plane relative to the photosensitive member;

resiliently biasing the toner bearing member toward the photosensitive member using a spring;

providing the spring with a spring constant sufficient to create a predetermined compressive force between the toner bearing member and the photosensitive member.

Another aspect of the invention provides a method of manufacturing or remanufacturing a process cartridge including the steps of:

providing a cartridge frame;

providing a toner bearing member rotatably mounted to the frame, the toner bearing member being adapted for developing a latent image carried on a photosensitive member;

providing a charging member for charging the photosensitive member;

mounting the charging member to the frame such that the charging member is allowed to move in at least one plane relative to the photosensitive member;

resiliently biasing the charging member toward the photosensitive member using a spring;

providing the spring with a spring constant sufficient to create a predetermined compressive force between the charging member and the photosensitive member.

Throughout this document, unless otherwise indicated to the contrary, the terms “comprising”, “consisting of”, and the like, are to be construed as non-exhaustive, or in other words, as meaning “including, but not limited to”.

### BRIEF DESCRIPTION OF THE DRAWINGS

The invention will now be described, by way of example only, with reference to the accompanying drawings, in which:

FIG. 1 is a perspective view of a process cartridge according to the invention, shown with the drum cover closed;

FIG. 2 is a perspective view of a process cartridge according to the invention, shown with the drum cover open;

FIG. 3 is a front view of the cartridge of FIG. 1;

FIG. 4 is a rear view of the cartridge of FIG. 1;

FIG. 5 is top view of the cartridge of FIG. 1;

FIG. 6 is a bottom view of the cartridge of FIG. 1;

FIG. 7 is perspective view of a lower frame of the cartridge of FIG. 1;

FIG. 8 is a perspective view of an upper frame of the cartridge of FIG. 1, shown without the drum cover attached;

FIG. 9 is a drive side perspective view of a developing sub-frame of the lower frame of FIG. 7;

FIG. 10 is an idle side perspective view of the developing sub-frame of FIG. 9;

FIG. 11 is a perspective view of a drum sub-frame of the lower frame of FIG. 7;

FIGS. 12A to 12C show perspective and elevational views of a drive side end bearing of the developing sub-frame of FIG. 9;

FIGS. 13A to 13C show perspective and elevational views of an idle side end bearing of the developing sub-frame of FIG. 10;

FIG. 14A to 14D show perspective and elevational views of a drive side end plate of the developing sub-frame of FIG. 9;

FIG. 15A to 15D show perspective and elevational views of an idle side end plate of the developing sub-frame of FIG. 10; and

FIG. 16 is a perspective view of the developing roller of the process cartridge of FIG. 1, shown with the end bearings of FIGS. 12 and 13 attached.

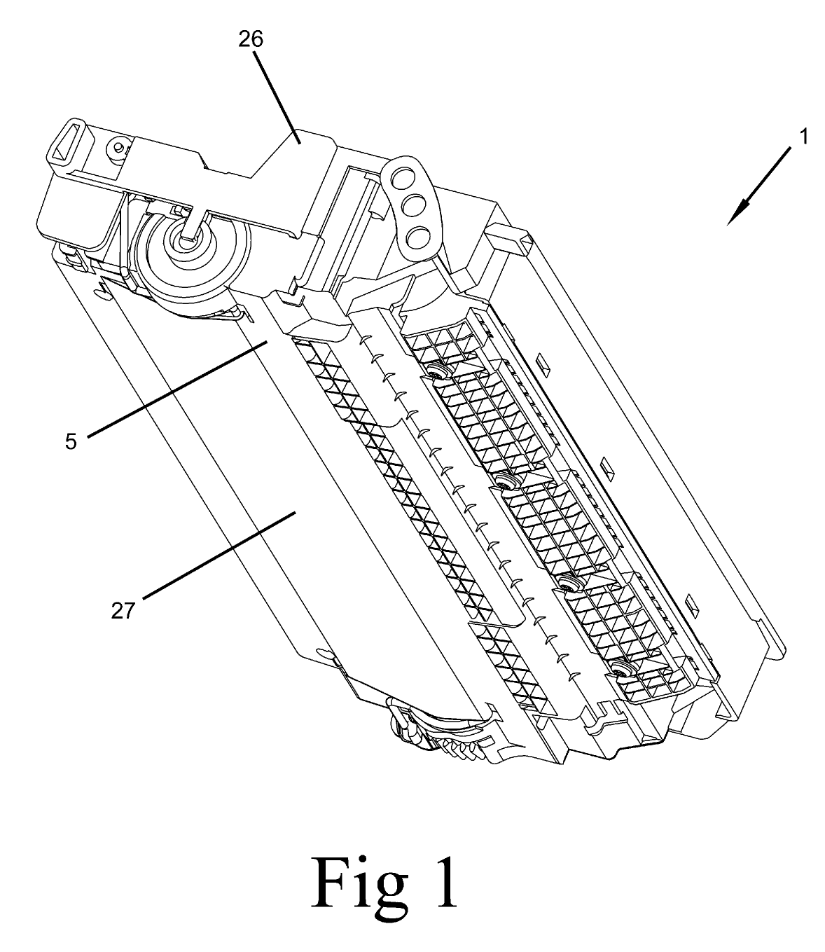

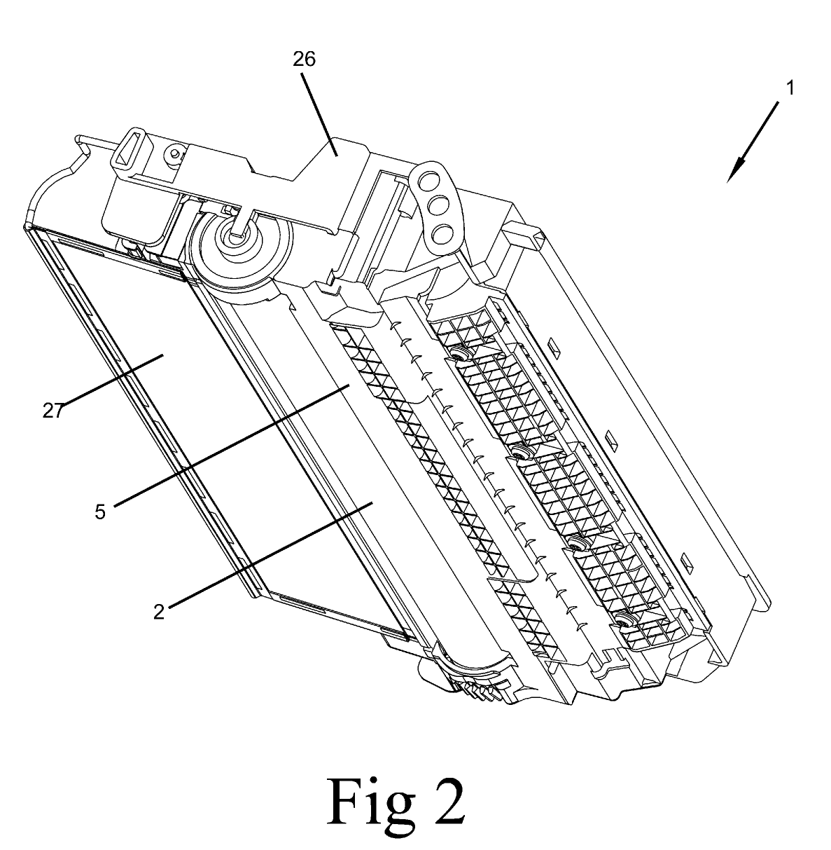

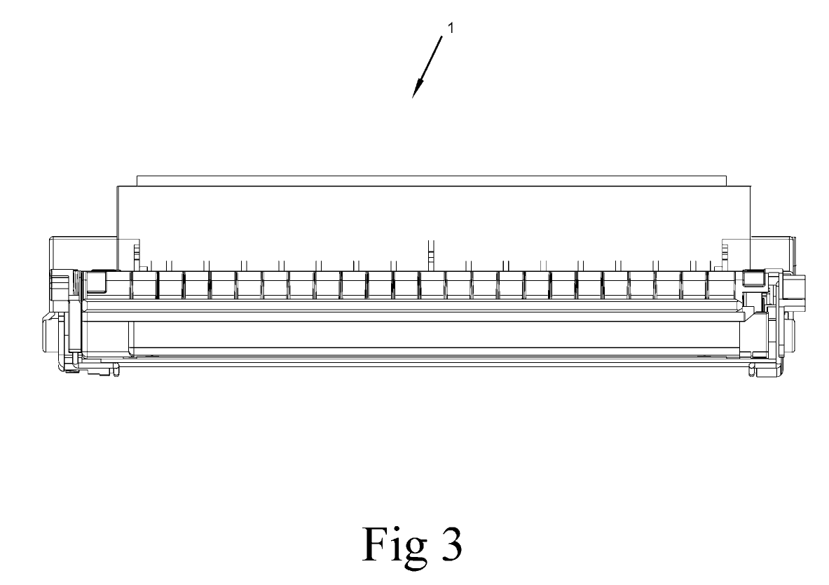

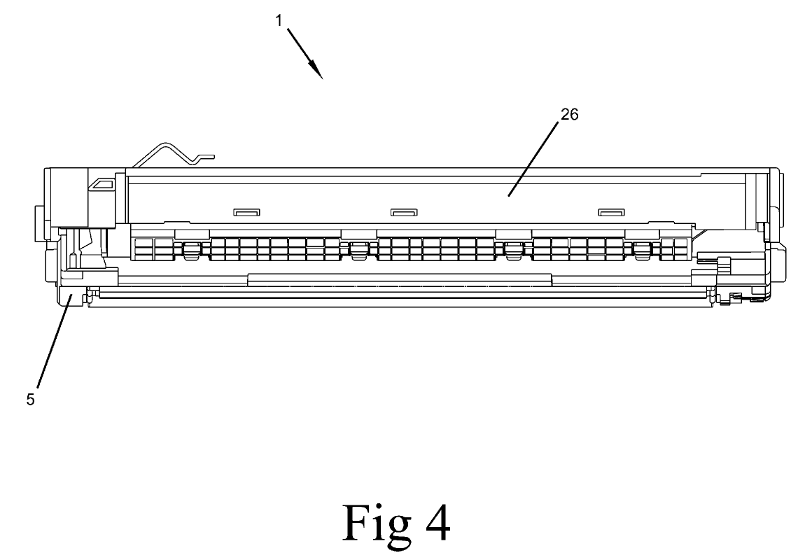

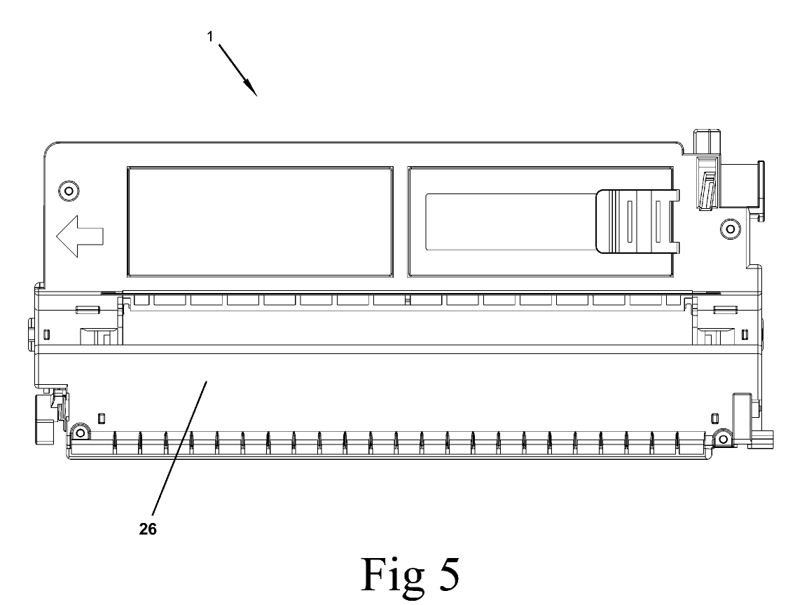

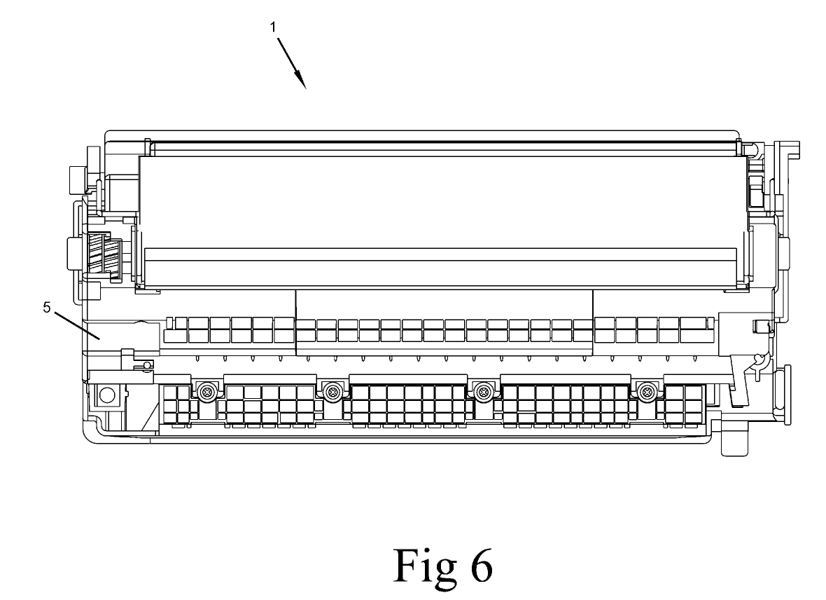

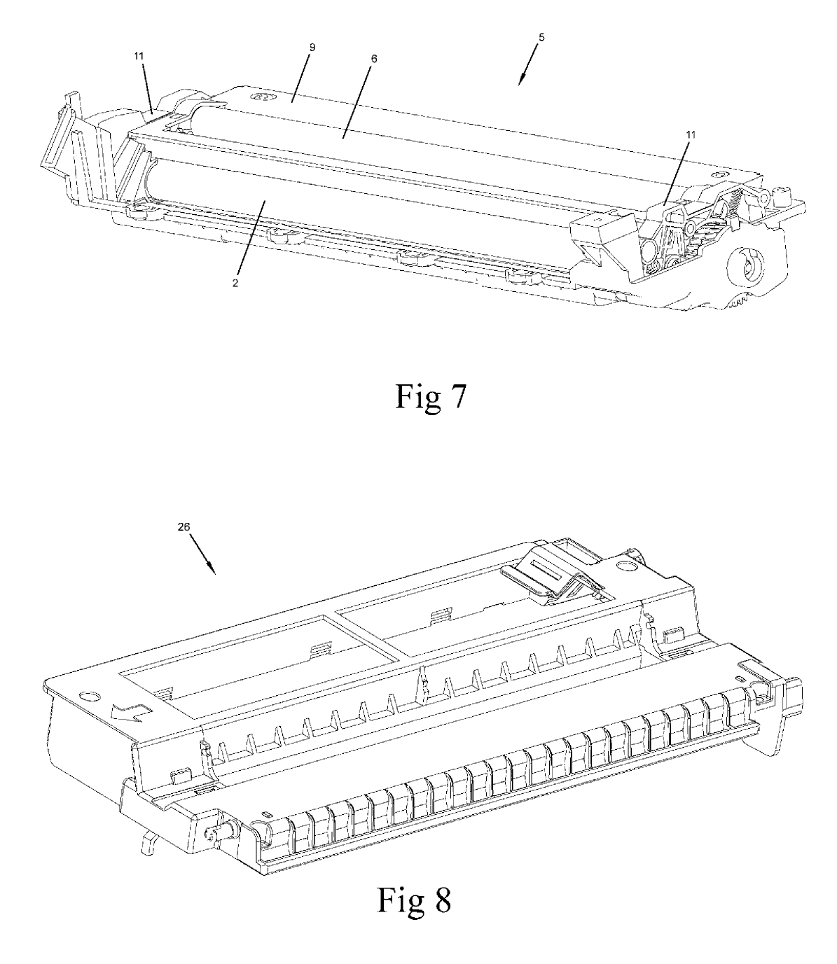

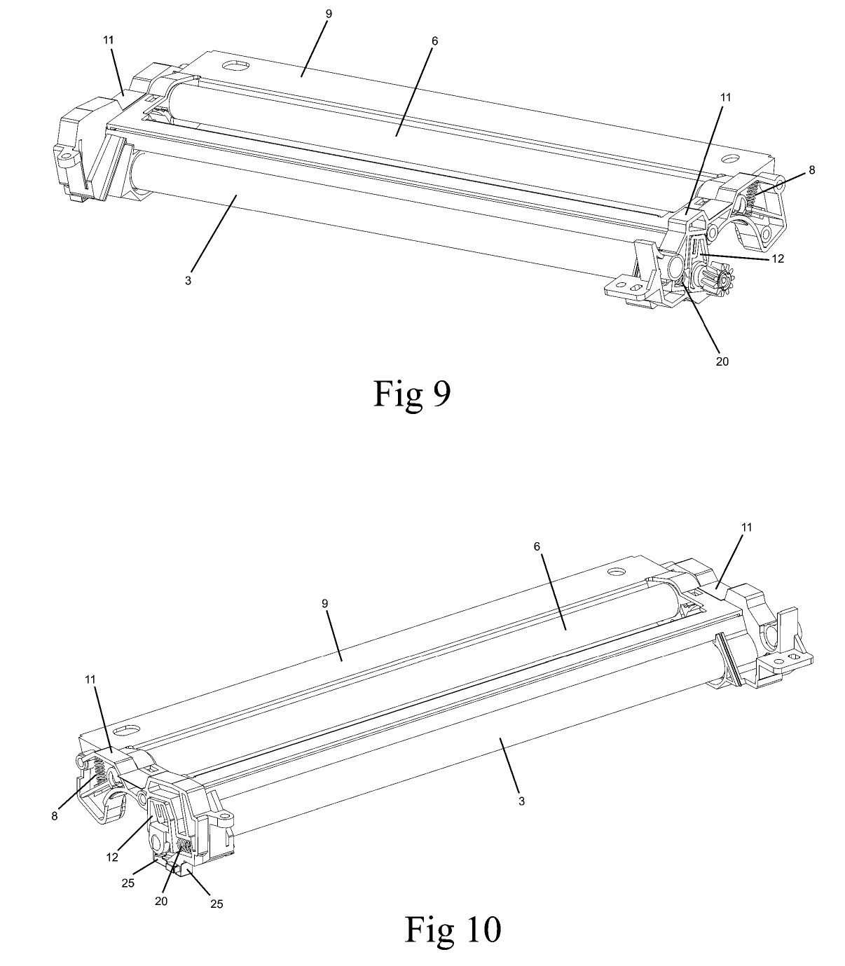

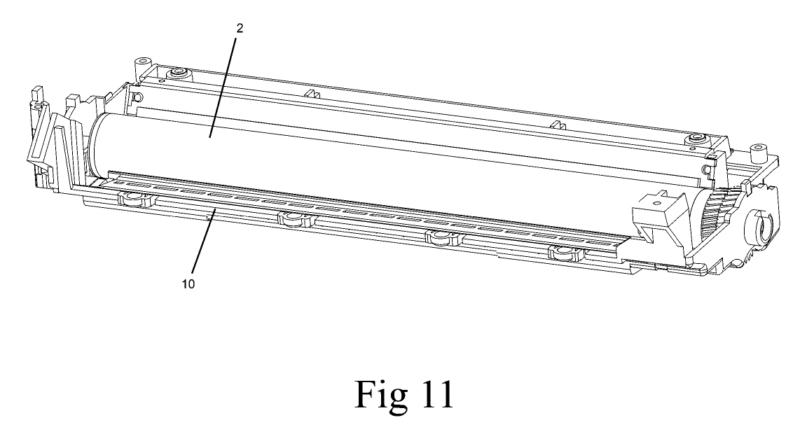

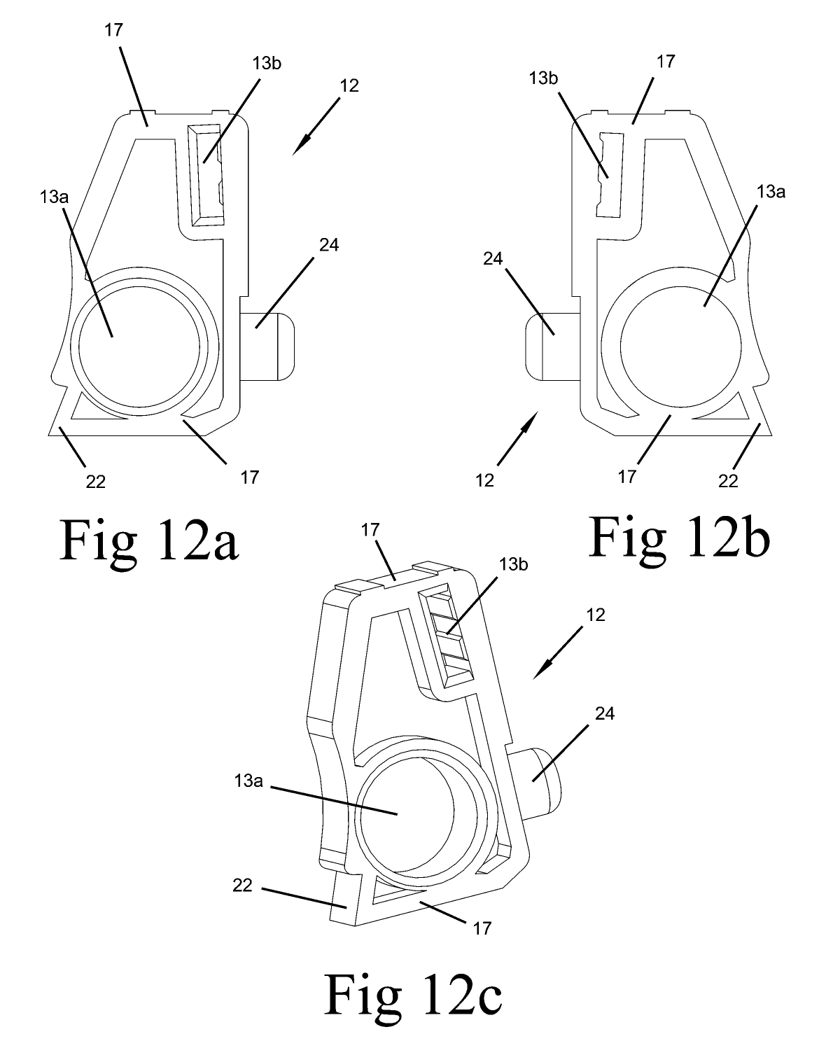

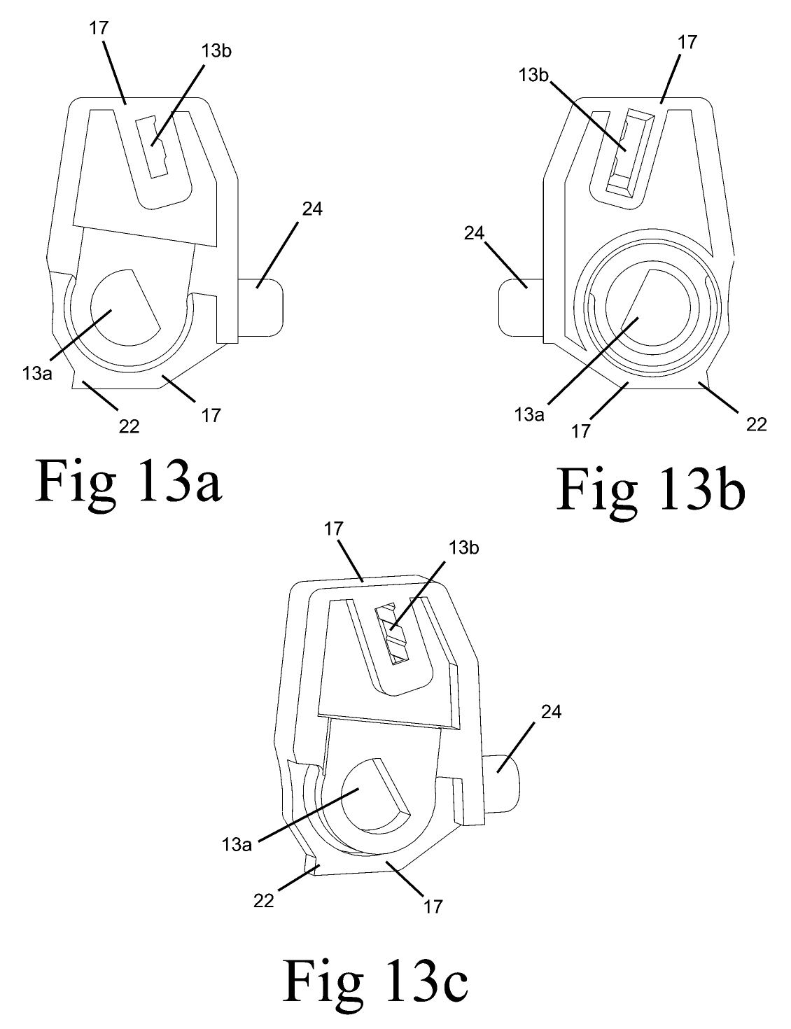

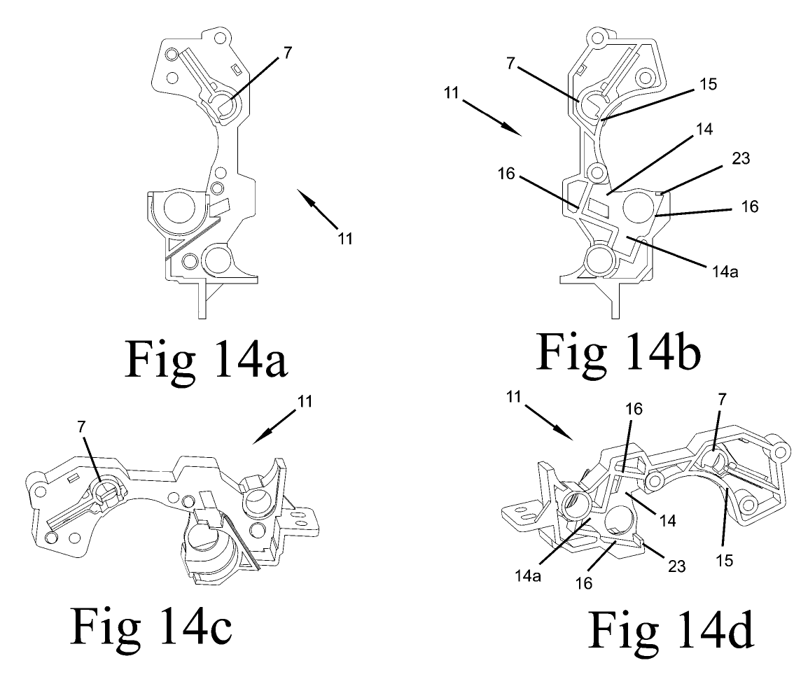

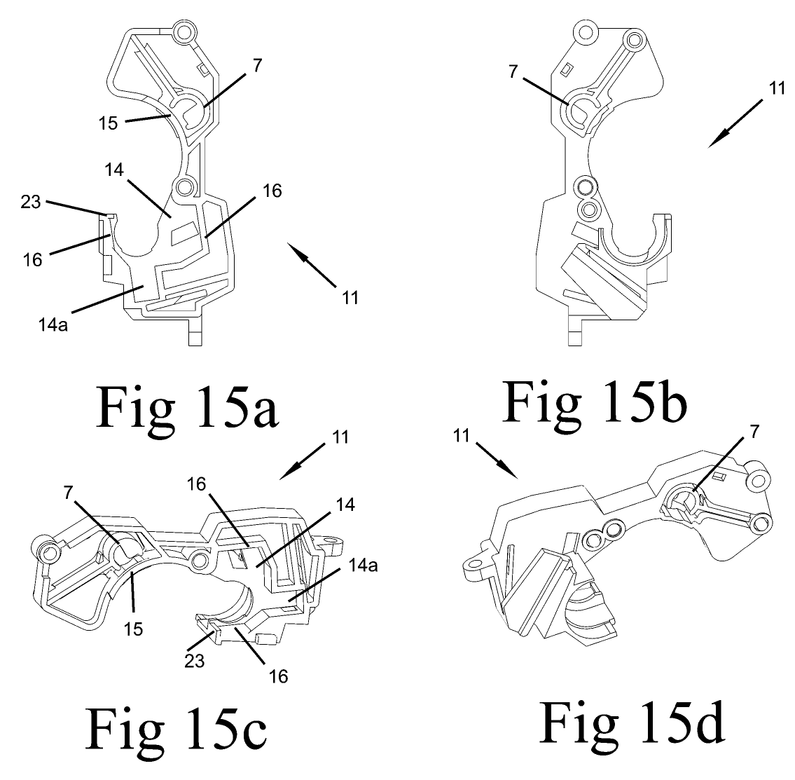

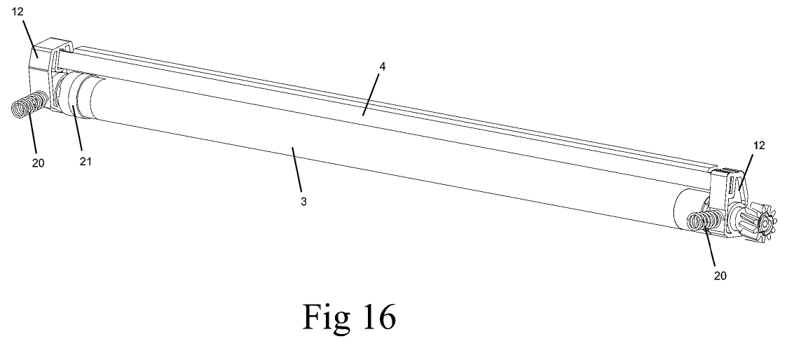

### PREFERRED EMBODIMENTS OF THE INVENTION

As will be understood by those skilled in the art, process cartridges can take the form of drum cartridges, developing cartridges and unitary cartridges. A drum cartridge is a cartridge that contains a photosensitive drum, upon which is formed a latent image for subsequent development by a developer. A developing cartridge is a cartridge that includes process elements for developing the latent image, such as a developing roller. A unitary cartridge is a cartridge that includes the drum and the process elements responsible for developing the latent image.

The present invention is applicable particularly to developing cartridges and unitary cartridges. However, the following description relates to a unitary cartridge.

Referring to the drawings, the cartridge 1 comprises a cartridge frame and a photosensitive drum 2 and developing roller 3 rotatably mounted to the frame. The developing roller is spaced apart from the drum for non-contact development of a latent image carried on the drum. A regulating blade 4 is engageable with the developing roller 3 for regulating an amount of toner carried on the developing roller.

The cartridge frame includes a lower frame 5 for mounting the drum 2, developing roller 3 and regulating blade 4. A primary charging roller 6 is also mounted to the lower frame 5 for contact charging the photosensitive drum 2. Both ends of the charging roller are mounted to the lower frame 5 by respective C-shaped clips 7 that are spring mounted to the lower frame. The C-shaped clips 7 are integrally formed as part of the lower frame. Respective compression springs 8 are provided to resiliently bias the C-shaped clips toward the photosensitive drum 2.

The compression springs 7 for biasing the charging roller against the drum have a spring constant of between around 0.5 kN/m and around 10 kN/m and preferably between around 1.5 kN/m and around 3.0 kN/m. Accordingly, the charging roller 6 is pressed against the drum 2 with a pressing force of between around 0.01 kN/m and around 0.1 kN/m and preferably between around 0.3 kN/m and around 0.7 kN/m.

The developing roller 3 and regulating member 4 are mounted to a rigid developing sub-frame 9. The drum is rotatably mounted to a drum sub-frame 10. The developing sub-frame 9 is fixedly connectable to the drum sub-frame 10. An end plate 111 is connected to opposite longitudinal ends of the developing sub-frame 9. A bearing 12 is provided at each longitudinal end of the developing sub-frame. The bearings 12 have mounting apertures 13a and 13b respectively for mounting respective ends of the developing roller 3 and regulating blade 4, and for maintaining a predetermined spacing between the developing roller and the regulating blade. The bearings 12 are moveable relative to the developing frame 9, and thereby to the drum frame 10, to allow relative movement between the developing roller 3 and photosensitive drum 2.

The end plates 11 have a recess 14 for locating the bearings 12 and an arcuate supporting surface 15 for supporting the ends of the photosensitive drum 2. The recesses 14 have opposite parallel guide walls 16 that cooperate with opposite parallel outer walls 17 of the bearings so as to restrict movement of the bearings to a single plane. The guide walls 16 extend generally toward the photosensitive drum 2. The recesses 14 also include a portion 14a for housing the compression springs 7 that urge the bearings 12 toward the drum 2.

The bearings 12 and recesses 14 are configured such that, in use, a longitudinally outer edge 18 of the bearings is substantially flush with a corresponding longitudinal end face 19 of the end plates 11.

A coil spring 20 is provided to bias the bearings 12 toward the drum 2 to create the required gap between the developing roller 3 and drum 2. The gap is maintained by spacers 21 mounted on the longitudinal ends of the developing roller 3. In addition, an abutting portion 22 is provided on the bearing 12 and is engageable with a stop portion 23 on the end plate 11 to limit movement of the bearing 12 toward the photosensitive drum 2. The abutting portion 22 and stop portion 23 serve to limit the movement of the bearing 12 even when the photosensitive drum 2 is not installed in the cartridge, for example, during assembly and disassembly of the cartridge. A locating boss 24 is provided on the bearings 12 to locate the coil spring 20.

In contact-type developing systems, the spring constant of the coil springs 20 that urge the bearings 12 is chosen so as to provide a sufficient pressing force between the developing roller 3 and the drum 2. The spring constant used in the illustrated embodiments is between around 0.5 kN/m and around 10 kN/m and preferably between around 1.5 kN/m and around 3.0 kN/m.

A potential bias contact 25 is electrically connected to one end of the developing roller sleeve for supplying a potential bias thereto. The bias contact 25 has a mounting aperture (not shown) that engages around the developing roller sleeve to hold the bias contact in position relative to the developing roller. Accordingly, when the developing roller 3 translates in response to movement of the bearing 12, the potential bias contact 25 also moves so as to maintain a constant relative disposition between the developing roller and the bias contact.

In use, the freedom of movement of the developing roller 3 toward and away from the drum 2, by virtue of its being mounted on the bearings 12, allows a constant spacing to be maintained between the developing roller and drum despite any surface imperfections that may exist in either component. Also, the resilient mounting of the developing roller allows any force concentrations caused by such imperfections, or by any sharp external force being applied to the cartridge, to be absorbed, thereby minimising the risk of damage to sensitive cartridge components. The mounting of both the regulating blade 4 and the developing roller 3 on the bearings 12 also allows the relative disposition of these components to be maintained despite relative movement between the developing roller 3 and drum 2.

The cartridge also includes an upper frame 26, which is fixedly connectable to the lower frame. A drum cover 27 is hingedly connected to the upper frame to protect the photosensitive drum from light when it is not in use.

It will also be appreciated that while the illustrated uses a non-contact developing system, the same principles can be applied by one of skill in the art to contact developing systems. In this respect, it is noted that the use of a bearing as described and illustrated, but in a contact developing system, allows for a constant spacing to be maintained between the developer roller and the drum, despite wear that may occur over time.

It will be appreciated that while the invention has been described with reference to specific examples, it may also be embodied in many other forms.

What is claimed is:

1. A process cartridge for an image forming apparatus, said process cartridge comprising:
a cartridge frame;
a toner bearing member rotatably mounted to the frame, the toner bearing member being adapted for developing a latent image carried on a photosensitive member;
a regulating blade engageable with the toner bearing member for regulating an amount of toner carried on the toner bearing member;
a bearing engageable with the cartridge frame for mounting the toner bearing member and regulating blade, the bearing member maintaining a predetermined spacing between the toner bearing member and the regulating blade;
wherein the bearing is moveable relative to the cartridge frame.

2. A process cartridge according to claim 1, wherein the bearing is resiliently biased toward a position wherein, in use, the toner bearing member opposes the photosensitive member.

3. A process cartridge according to claim 1, comprising an abutting portion on the bearing engageable with a stop portion on the cartridge frame to limit movement of the bearing toward the photosensitive member.

4. A process cartridge according to claim 1, wherein the bearing includes an aperture for engagement by a supporting bracket of the regulating blade.

5. A process cartridge according to claim 1, wherein the bearing includes an aperture for engagement by a shaft connected to the toner bearing member.

6. A process cartridge according to claim 5, comprising a potential bias contact connected to the shaft of the toner bearing member for supplying a potential bias to the toner bearing member, such that in use the potential bias contact moves as the bearing moves.

7. A process cartridge according to claim 1, comprising a compression spring for resiliently biasing the bearing toward a position wherein, in use, the toner bearing member opposes the photosensitive member.

8. A process cartridge according to claim 7, wherein the spring has a spring constant of between around 0.5 kN/m and around 10 kN/m.

9. A process cartridge according to claim 7, wherein the spring has a spring constant of between around 1.0 kN/m and around 4.0 kN/m.

10. A process cartridge according to claim 7, wherein the spring has a spring constant of between around 1.5 kN/m and around 3.0 kN/m.

11. A process cartridge according to claim 7, wherein the bearing has a boss for locating the spring.

12. A process cartridge according to claim 1, including a recess in the cartridge frame for locating the bearing.

13. A process cartridge according to claim 12, wherein the recess is configured to restrict movement of the bearing to a single plane.

14. A process cartridge according to claim 12, wherein the recess has opposite parallel guide walls that cooperate with opposite parallel outer walls of the bearing so as to restrict movement of the bearing to a single plane.

15. A process cartridge according to claim 14, wherein the guide walls extend generally toward the photosensitive drum.

16. A process cartridge according to claim 1, wherein a longitudinally outer edge of the bearing is substantially flush with a corresponding longitudinal end face of the cartridge frame.

17. A process cartridge according to claim 1, wherein the cartridge frame includes an outer frame for mounting the drum and a sub-frame to which the toner bearing member and regulating member are mounted via said bearing.

18. A process cartridge according to claim 17, including a charging member mounted to the sub-frame for charging the photosensitive member.

19. A process cartridge according to claim 18, wherein both ends of the charging member are mounted to the sub-frame by respective C-shaped clips that are spring mounted to the sub-frame.

20. A process cartridge according to claim 19, wherein the C-shaped clips are integrally formed as part of the sub frame.

21. A process cartridge according to claim 19, wherein respective compression springs are provided to resiliently bias the C-shaped clips toward the photosensitive member.

22. A process cartridge according to claim 1, wherein the cartridge frame includes an end plate at its opposite longitudinal ends.

23. A process cartridge according to claim 22, including a recess in the end plate for locating the bearing.

24. A process cartridge according to claim 22, including an arcuate supporting surface on the end plate for supporting a photosensitive drum.

25. A process cartridge according to claim 22, wherein each said end plate is connected to an opposite longitudinal end of a rigid supporting sub-frame.

26. A process cartridge for an image forming apparatus, said process cartridge comprising:
a cartridge frame;
a toner bearing member rotatably mounted to the frame, the toner bearing member being adapted for developing a latent image carried on a photosensitive member;
a regulating blade engageable with the toner bearing member for regulating an amount of toner carried on the toner bearing member;
a spring for urging the toner bearing member toward the photosensitive member, the spring having a spring constant of between around 0.5 kN/m and around 10 kN/m.

27. A process cartridge according to claim 25, wherein the spring constant is between around 1.0 kN/m and around 4.0 kN/m.

28. A process cartridge according to claim 25, wherein the spring constant is between around 1.5 kN/m and around 3.0 kN/m.

29. A process cartridge according to claim 25, including a said spring at each longitudinal end of the toner carrying member.

30. A process cartridge for an image forming apparatus, said process cartridge comprising:
a cartridge frame;
a toner bearing member rotatably mounted to the frame, the toner bearing member being adapted for developing a latent image carried on a photosensitive member;
a charging member for charging the photosensitive member;
a spring for urging the charging member toward the photosensitive member to generate a pressing force between the charging member and the photosensitive member of between around 0.01 kN/m and around 0.1 kN/m.

31. A process cartridge according to claim 30, wherein the pressing force is between around 0.3 kN/m and around 0.7 kN/m.

32. A process cartridge according to claim 30, wherein the spring has a spring constant of between around 0.5 kN/m and around 10 kN/m.

33. A process cartridge according to claim 30, wherein the spring has a spring constant of between around 1.0 kN/m and around 4.0 kN/m.

34. A process cartridge according to claim 30, wherein the spring has a spring constant of between around 1.5 kN/m and around 3.0 kN/m.

35. A process cartridge according to claim 30, including a said spring at each longitudinal end of the charging member.

36. A process cartridge for an image forming apparatus, said process cartridge comprising:
a cartridge frame;
a toner bearing member rotatably mounted to the frame, the toner bearing member being adapted for developing a latent image carried on a photosensitive member;
a charging member for charging the photosensitive member;
a spring for urging the charging member toward the photosensitive member, the spring having a spring constant of between around 0.5 kN/m and around 10 kN/m.

37. A process cartridge according to claim 36, wherein the spring constant is between around 1.0 kN/m and around 4.0 kN/m.

38. A process cartridge according to claim 36, wherein the spring constant is between around 1.5 kN/m and around 3.0 kN/m.

39. A process cartridge according to claim 36, including a said spring at each longitudinal end of the charging member.

40. A method of manufacturing or remanufacturing a process cartridge including the steps of:
providing a cartridge frame;
providing a toner bearing member rotatably mounted to the frame, the toner bearing member being adapted for developing a latent image carried on a photosensitive member;
mounting the toner bearing member to the frame such that the toner bearing member is allowed to move in at least one plane relative to the photosensitive member;
resiliently biasing the toner bearing member toward the photosensitive member using a spring;
providing the spring with a spring constant of between around 0.5 kN/m and around 10 kN/m.

41. A method according to claim 40, wherein the spring constant is between around 1.0 kN/m and around 4.0 kN/m.

42. A method according to claim 40, wherein the spring constant is between around 1.5 kN/m and around 3.0 kN/m.

43. A method according to claim 40, including the step of restricting translational movement of the toner bearing relative to the photosensitive member, in use, to a single plane.

44. A method according to claim 40, wherein a said spring is provided at each longitudinal end of the toner bearing member.

45. A method of manufacturing or remanufacturing a process cartridge including the steps of:
providing a cartridge frame;
providing a toner bearing member rotatably mounted to the frame, the toner bearing member being adapted for developing a latent image carried on a photosensitive member;
providing a charging member for charging the photosensitive member;
mounting the charging member to the frame such that the charging member is allowed to move in at least one plane relative to the photosensitive member;
resiliently biasing the charging member toward the photosensitive member using a spring;
providing the spring with a spring constant sufficient to create a predetermined compressive force between the charging member and the photosensitive member.

46. A method according to claim 45, wherein the pressing force is between around 0.01 kN/m and around 0.1 kN/m.

47. A method according to claim 45, wherein the pressing force is between around 0.3 kN/m and around 0.7 kN/m.

48. A method according to claim 45, wherein the spring constant is between around 0.5 kN/m and around 10 kN/m.

49. A method according to claim 45, wherein the spring constant is between around 1.0 kN/m and around 4.0 kN/m.

50. A method according to claim 45, wherein the spring constant is between around 1.5 kN/m and around 3.0 kN/m.

51. A method according to claim 45, wherein the spring is a coil spring.
